(19) United States
(12) Patent Application Publication
(10) Pub. No.: US 2010/0313274 A1
(43) Pub. Date: Dec. 9, 2010

(54) IMAGE SERVER WITH MULTIPLE IMAGE CONFIDENTIALITY PORTS

(75) Inventor: Kevin M. Crucs, Copley, OH (US)

Correspondence Address: HAHN LOESER & PARKS, LLP, One GOJO Plaza, Suite 300, AKRON, OH, 44311-1076, US

(73) Assignee: Apteryx, Inc., Akron, OH (US)

(21) Appl. No.: 12/834,070

(22) Filed: Jul. 12, 2010

Related U.S. Application Data
(63) Continuation-in-part of application No. 12/246,647, filed on Oct. 7, 2008.

(51) Int. Cl. G06F 17/30

(52) U.S. Cl. 726/26

(57) ABSTRACT

Image servers, methods, software applications, and computer readable medium for retrieving images of various levels of patient anonymity via multiple image confidentiality software ports. In an image server, at least two image confidentiality software ports are provided, where each of the image confidentiality software ports is capable of providing images at a predetermined level of patient anonymity, and where the predetermined level of patient anonymity is different for each of the image confidentiality software ports.

This U.S. patent application is a continuation-in-part (CIP) of and claims the benefit of and priority to U.S. patent application Ser. No. 12/246,647 filed on Oct. 7, 2008 which is incorporated herein by reference in its entirety.

### TECHNICAL FIELD

Certain embodiments of the present invention relate to an image server and methods of querying an image server. More particularly, certain embodiments relate to an image server providing multiple image confidentiality software ports and methods of querying the image server for images having different levels of patient anonymity.

### BACKGROUND

An image server is a server that is specialized for delivering images and is often used as a complement to a web server to increase the speed of image retrieval. Digital Imaging and Communications in Medicine (DICOM) is a well-known standard for transferring images and associated information between devices manufactured by various vendors. One type of image server is a DICOM database server. Typically, a DICOM database server is used to store, organize, and manage medical images. Various external systems may desire to communicate with a DICOM database server to store images to the DICOM database server and/or to retrieve images from the DICOM database server by submitting image requests to the DICOM database server.

However, the DICOM standard provides for more than the transferring and storing of digital medical images. Other DICOM functions include media storage, query/retrieve, worklist query, make image hard copies, study and results management, print management, worklist management, and test connectivity verification.

A basic concept used in the DICOM standard is that of “Services on Objects”. An example of an “object” is an X-ray image. Two examples of a “service” are the “query/retrieve” and “store” functions. In the DICOM standard, processes of operating on objects are called “Service Object Pair Classes” (SOP Classes). Examples of SOP Classes include “store an X-ray image”, “print an X-ray image”, and “retrieve a worklist”

Unique Identifiers (UID's) are determined for SOP classes and are also applied to studies, series, and images. A patient study includes a study component such as, for example, an examination using a particular type of medical imaging machine. The images that are captured in sequence during the study on a patient form a series of objects.

The DICOM standard is founded on a client/server concept. A device that uses a service is the client device, and the device that provides the service is the server device. The client device is called a Service Class User (SCU). The server device is called a Service Class Provider (SCP). An SCU transmits a Service Request to an SCP over a network. The SCP transmits back a response to the SCU over the network. For information to be transferred between a SCP and a SCU, a communication syntax (e.g., a DICOM protocol) must be agreed upon and association between the SCU and the SCP must be opened.

The DICOM standard facilitates communication of digital medical images of various types including X-ray, computerized tomography, magnetic resonance, and ultrasound, for example. DICOM activities are administered in a queued manner via application software running on a host computer. The host computer may be an integral part of a medical imaging machine, for example, or a workstation in a medical office.

A PACS (Picture Archive and Communication System) is an image management system typically used in a radiology department of a healthcare facility such as a hospital or a doctor's office, for example. A PACS system may manage the details of imaging related tasks within a facility including acquisitions, archiving, manipulation, and display. A PACS system may be implemented in the form of a local DICOM database server and a database, for example.

A DICOM client typically needs to know which DICOM database server to select and query, depending on the information that is being requested. IP addresses and predefined software ports are often used to identify a server and a particular server application on a network. For example, a particular server application may be that of providing images to requesting clients. The concepts of IP addresses and software ports are well known in the art.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

A first embodiment of the present invention comprises an image server providing at least two image confidentiality software ports. Each of the image confidentiality software ports is capable of providing images at a predetermined level of patient anonymity, where the predetermined level of patient anonymity is different for each of the image confidentiality software ports.

Another embodiment of the present invention comprises an image server providing multiple image confidentiality software ports. The image server includes a first software port capable of providing images at a first level of patient anonymity, a second software port capable of providing images at a second level of patient anonymity, where the second level of patient anonymity is different from the first level of patient anonymity, and a third software port capable of providing images at a third level of patient anonymity, where the third level of patient anonymity is different from the first level of patient anonymity and the second level of patient anonymity. For example, the first level of patient anonymity may correspond to a maximum level of patient anonymity, the second level of patient anonymity may correspond to an intermediate level of patient anonymity, and the third level of patient anonymity may correspond to a minimum level of patient anonymity. For example, the images provided by the third software port may be provided along with at least one of a patient name and a patient social security number. In accordance with an embodiment of the present invention, the port numbers of the first, second, and third software ports may be 104, 105, and 106 respectively. The image server may be a Digital Imaging and Communications in Medicine (DICOM) Picture Archive and Communication System (PACS) server, in accordance with an embodiment of the present invention.

A further embodiment of the present invention comprises a method of querying an image server providing multiple image confidentiality software ports. The method includes querying an image server by providing a first port number in a first query message, wherein the first port number corresponds to a first software port of the image server capable of providing images at a first level of patient anonymity. The method further includes receiving at least one image from the image server having the first level of patient anonymity in response to the first query message. The method also includes, displaying the at least one image having the first level of patient anonymity. The method further includes querying the image server by providing a second port number in a second query message, wherein the second port number corresponds to a second software port of the image server capable of providing images at a second level of patient anonymity. The method also includes receiving the at least one image from the image server having the second level of patient anonymity in response to the second query message. The method may further include displaying the at least one image having the second level of patient anonymity. The method may also include querying the image server by providing a third port number in a third query message, wherein the third port number corresponds to a third software port of the image server capable of providing images at a third level of patient anonymity. The method may further include receiving the at least one image from the image server having the third level of patient anonymity in response to the third query message. The method may also include displaying the at least one image having the third level of patient anonymity.

Another embodiment of the present invention comprises a method of querying an image server. The method includes providing one of a plurality of software port numbers in a query message, wherein each of the plurality of software port numbers corresponds to a different image confidentiality software port of the image server, and wherein the image server is capable of providing images at a different level of patient anonymity for each image confidentiality software port. The first software port number of the plurality of software port numbers corresponds to a first image confidentiality software port capable of providing images at a maximum level of patient anonymity. The second software port number of the plurality of software port numbers corresponds to a second image confidentiality software port capable of providing images at an intermediate level of patient anonymity. The third software port number of the plurality of software port numbers corresponds to a third image confidentiality software port capable of providing images at a minimum level of patient anonymity.

A further embodiment of the present invention comprises a software application residing on a computer-based platform. The software application is capable of querying an image server by providing one of a plurality of software port numbers in a query message, wherein each of the plurality of software port numbers corresponds to a different image confidentiality software port of the image server, and wherein the image server is capable of providing images at a different level of patient anonymity for each image confidentiality software port.

Another embodiment of the present application comprises a software application residing on a computer-based platform. The software application is capable of querying an image server by providing a first port number in a first query message, wherein the first port number corresponds to a first software port of the image server and is capable of providing images at a first level of patient anonymity. The software application is also capable of receiving at least one image from the image server having the first level of patient anonymity in response to the first query message. The software application is further capable of displaying the at least one image having the first level of patient anonymity. The software application is also capable of querying the image server by providing a second port number in a second query message, wherein the second port number corresponds to a second software port of the image server and is capable of providing images at a second level of patient anonymity. The software application is further capable of receiving the at least one image from the image server having the second level of patient anonymity in response to the second query message and displaying the at least one image having the second level of patient anonymity. The software application may be further capable of querying the image server by providing a third port number in a third query message, wherein the third port number corresponds to a third software port of the image server and is capable of providing images at a third level of patient anonymity. The software application may also be capable of receiving the at least one image from the image server having the third level of patient anonymity in response to the third query message and displaying the at least one image having the third level of patient anonymity.

A further embodiment of the present invention comprises a non-transitory computer readable medium having encoded thereon computer executable instructions for performing a method. The method includes querying an image server by providing one of a plurality of software port numbers in a query message, wherein each of the plurality of software port numbers corresponds to a different image confidentiality software port of the image server, and wherein the image server is capable of providing images at a different level of patient anonymity for each image confidentiality software port.

Another embodiment of the present invention comprises a non-transitory computer readable medium having encoded thereon computer executable instructions for performing a method. The method includes querying an image server by providing a first port number in a first query message, wherein the first port number corresponds to a first software port of the image server and is capable of providing images at a first level of patient anonymity. The method further includes receiving at least one image from the image server having the first level of patient anonymity in response to the first query message, and displaying the at least one image having the first level of patient anonymity. The method also includes querying the image server by providing a second port number in a second query message, wherein the second port number corresponds to a second software port of the image server and is capable of providing images at a second level of patient anonymity. The method further includes receiving the at least one image from the image server having the second level of patient anonymity in response to the second query message, and displaying the at least one image having the second level of patient anonymity. The method may also include querying the image server by providing a third port number in a third query message, wherein the third port number corresponds to a third software port of the image server and is capable of providing images at a third level of patient anonymity. The method may further include receiving the at least one image from the image server having the third level of patient anonymity in response to the third query message, and displaying the at least one image having the third level of patient anonymity.

A further embodiment of the present invention comprises a method of querying an image server. The method includes receiving an image query message from a client, the query message having a client application entity title (AET). The method further includes associating the client AET with one of at least two levels of patient anonymity, and providing at least one image at the one of at least two levels of patient anonymity, via an image confidentiality software port corresponding to a predefined level of patient anonymity, in response to the image query message.

Another embodiment of the present invention comprises a method of querying an image server. The method includes providing a client AET in a query message to the image server, wherein the client AET is associated by the image server with one of at least two levels of patient anonymity, and wherein the image server is configured to provide images at the at least two levels of patient anonymity, via image confidentiality software ports each corresponding to a predefined level of patient anonymity, in response to the query message.

A further embodiment of the present invention comprises a software application residing on an image server. The software application is configured to receive an image query message from a client, where the query message has a client AET. The software application is further configured to associate the client AET with one of at least two levels of patient anonymity. The software application is also configured to provide images at the at least two levels of patient anonymity via image confidentiality software ports, each corresponding to a predefined level of patient anonymity, in response to the image query message.

Another embodiment of the present invention comprises a non-transitory computer readable medium having encoded thereon computer executable instructions for performing a method. The method includes receiving an image query message from a client, the query message having a client AET. The method further includes associating the client AET with one of at least two levels of patient anonymity, and providing at least one image at the one of at least two levels of patient anonymity, via an image confidentiality software port corresponding to a predefined level of patient anonymity, in response to the image query message.

A further embodiment of the present invention comprises a method of querying an image server. The method includes receiving an image query message from a client, the query message having a client transfer identifier (ID), associating the client transfer ID with one of at least two levels of patient anonymity, and providing at least one image at the one of at least two levels of patient anonymity, via an image confidentiality software port in response to the image query message.

Another embodiment of the present invention comprises a method of querying an image server. The method includes receiving a first image query message from a first client, the first query message having a first client transfer identifier (ID), associating the first client transfer ID with one of at least two levels of patient anonymity, and providing at least one image at the one of at least two levels of patient anonymity to the first client, via a software port in response to the first image query message. The method also includes receiving a second image query message from a second client, the second query message having a second client transfer identifier (ID), associating the second client transfer ID with the one of at least two levels of patient anonymity, and providing at least one image at the one of at least two levels of patient anonymity to the second client, via the software port in response to the second image query message.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a system that uses image servers, a software application, and muliti-port methods for retrieving images of various image quality levels via multiple image quality software ports, in accordance with an embodiment of the present invention;

FIG. 2 illustrates a plurality of images retrieved using the system of FIG. 1 using an image quality software port corresponding to a lowest level of image quality, in accordance with an embodiment of the present invention;

FIGS. 3A-3C illustrate images retrieved using the system of FIG. 1 using three different image quality software ports of increasing levels of image quality, in accordance with an embodiment of the present invention;

FIG. 4 is a flowchart of an embodiment of a method of querying an image server providing multiple image quality software ports using the system of FIG. 1;

FIG. 5 illustrates a system that uses image servers, a software application, and muliti-port methods for retrieving images of various patient anonymity levels via multiple image confidentiality software ports, in accordance with an embodiment of the present invention;

FIG. 6 illustrates a plurality of images retrieved using the system of FIG. 5 using an image confidentiality software port corresponding to a lowest level of patient anonymity, in accordance with an embodiment of the present invention;

FIGS. 7A-7C illustrate images retrieved using the system of FIG. 5 using three different image confidentiality software ports of increasing levels of patient anonymity, in accordance with an embodiment of the present invention;

FIG. 8 is a flowchart of an embodiment of a method of querying an image server providing multiple image confidentiality software ports using the system of FIG. 5; and

FIG. 9 is a flowchart of another embodiment of a method of querying an image server providing multiple image confidentiality software ports using the system of FIG. 5.

### DETAILED DESCRIPTION

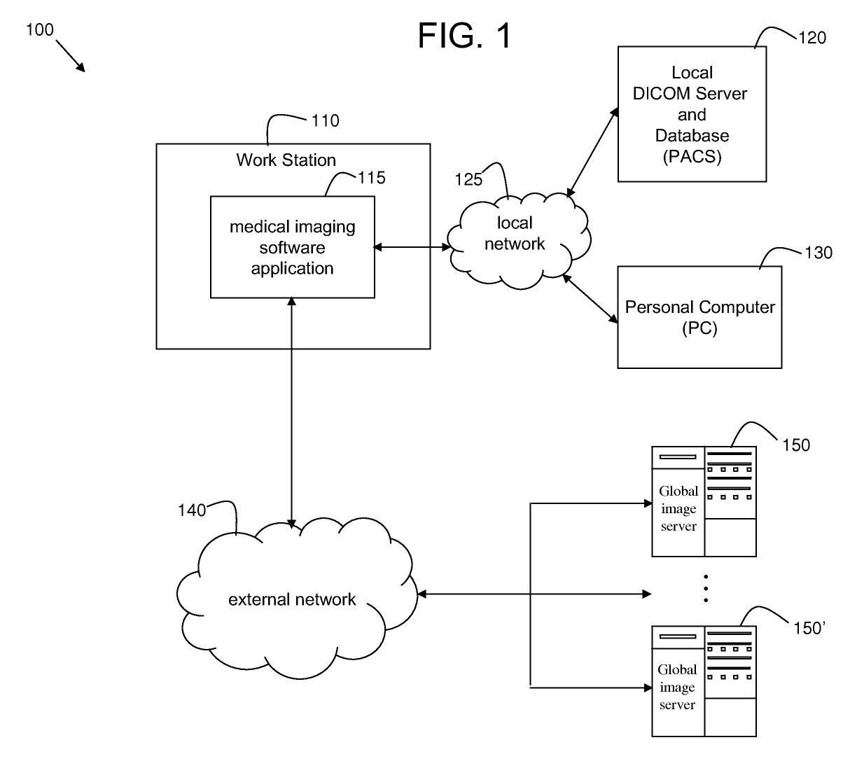

FIG. 1 illustrates a system 100 that uses image servers, a software application, and multi-port methods for retrieving images of various image quality levels via multiple image quality software ports, in accordance with an embodiment of the present invention. The system 100 includes a medical imaging software application 115 residing on a work station 110. The software application 115 is used to query image servers to retrieve medical images which may be displayed and viewed on the work station 110 by a user. The system also includes a local imaging server 120 being that of a local DICOM server and database. The local server 120 may serve as a PACS (Picture Archive and Communication System) as used in a radiology department of a healthcare facility such as a hospital or a doctor's office, for example. A PACS system may manage the details of imaging related tasks within a facility including acquisitions, archiving, manipulation, and display.

The system 100 further includes a local network 125 (e.g., a local area network) operatively connecting the work station 110 and the local server 120. The system may further include a personal computer (PC) 130 operatively connected to the local network 125. The system also includes a plurality of global image servers 150-150′ (e.g., DICOM database servers) and an external network 140 (e.g., the Internet) operatively connecting the work station 110 to the global image servers 150-150′. As used herein, the term “DICOM database server” refers to a DICOM server and associated database(s). A DICOM database server is capable of storing and/or archiving at least medical image information.

In accordance with an embodiment of the present invention, the local image server 120 and the global image servers 150-150′ each include three image quality software ports. An image quality software port, as used herein, is a software port of an image server that is capable or providing images or image data via that software port having a particular predetermined level of image quality. For example, a first software port may provide images at a maximum level of image quality, a second software port may provide images at 50% of the maximum level of image quality, and a third software port may provide images at 10% of the maximum level of image quality (e.g., thumbnail images).

A software port number uniquely identifies a particular service on a host server or computer. For example, in order for an image server to accept connections from remote workstations and computers, the image server binds each image server application to a local software port. The image server uses the local port to listen for and accept connections from remote systems. Once a remote system is connected, the image server may send the requested images to the remote system and then disconnect from the remote system when finished. In accordance with an embodiment of the present invention, image server applications corresponding to images of a particular level of image quality are bound to a particular image quality software port.

The term “image quality”, as used herein, refers to the total number of pixels or data that are used to represent an image. The more pixels or data (e.g., Megabytes) that are used to represent an image, the higher the level of image quality. An image having a lower level of image quality (e.g., having a half set of pixels) may have, for example, a lower perceived spatial resolution than the same image at a higher level of image quality (e.g., having a full set of pixels). Furthermore, the image having the lower level of image quality may have, for example, a lower perceived contrast resolution than the same image at a higher level of image quality. Other perceived differences are possible as well.

However, by allowing images to be retrieved from image servers at different levels of image quality (via multiple image quality software ports), network traffic may be reduced. For example, a user of the medical imaging software application 115 on the medical work station 110 may desire to view a set of dental X-ray images. The dental X-ray images reside on the local image server 120 or a global image server 150, and the software application 115 is capable of querying the correct image server for the images and retrieving those images (e.g., using the DICOM protocol). For example, if the desired images reside on the local image server 120 then, if the user retrieves the set of dental X-ray images at the maximum level of image quality, network traffic on the local network 125 may be greatly affected while the local image server 120 attempts to provide the many megabytes of full image quality image data to the work station 110.

The present invention, however, allows the user to initially retrieve the set of dental X-ray images at a significantly lower level of image quality (i.e., fewer megabytes), allowing the user to look at the full set of images and decide which of those images the user is really interested in for full image quality viewing. For example, the user may only be interested in one or two images of a set of a dozen images. The user may select the one or two images from the initially retrieved set of images and query the local image server 120 to retrieve those one or two images, but at a maximum level of image quality.

As a result of such a process, the overall network traffic on the local network 125 is reduced, or at least better managed. Embodiments of the present invention allow images to be retrieved at different levels of image quality by providing an image server with multiple software ports where each software port corresponds to a different level of image quality. When the medical imaging software application 115 makes a query to an image server to retrieve an image(s), the query message from the medical imaging software application 115 not only includes an IP address of the image server, but also includes an image quality software port number corresponding to the level of image quality at which the image(s) are to be retrieved.

In accordance with an embodiment of the present invention, the medical imaging software application 115 may be stored on a computer readable medium such as, for example, a compact disk (CD) for distribution. In accordance with other alternative embodiments of the present invention, the medical imaging software application 115 may reside the PC 130 which operatively interfaces to the work station 110 via the local network 125, or may reside on the local image server 120, for example.

An image server specializes in delivering images. An image server may perform specialized processing tasks that are useful to a user including, for example, image rotation, color adjustment, and image blending. In accordance with an embodiment of the present invention, an image server may process an image, having a predefined maximum level of image quality, in order to create corresponding images having lower levels of image quality. The image is the same, but the level of image quality is different. In this manner, an image server may provide duplicate images of various levels of image quality such that any particular level of image quality corresponds to a particular image quality software port of the image sever. In other words, the image server may provide multiple image retrieval applications based on image quality level, where each application is tied to a corresponding image quality software port.

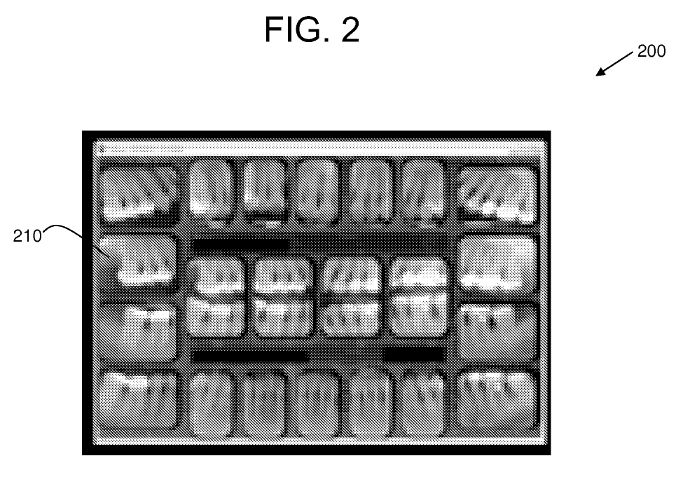

FIG. 2 illustrates a plurality of images 200 retrieved using the system 100 of FIG. 1 using an image quality software port corresponding to a lowest level of image quality, in accordance with an embodiment of the present invention. The images 200 may be displayed to a user on a display of the workstation 110, for example. The images 200 appear to be of low image quality but were able to be retrieved relatively quickly, using the lowest level image quality software port, thus keeping network traffic relatively low. The user may view the images 200 and decide he is interested in looking more closely at image 210, for example. As a result, the user selects the image 210 via the medical imaging software application 115 on the work station 110, selects a higher level of desired image quality, and again sends out a query message to retrieve only the image 210, but at the selected higher level of image quality.

When the user selects a higher level of desired image quality, the query message will include a different image quality software port number of the image server. For example, the original set of images 200 may have been queried and retrieved using software port number 104 corresponding to a DICOM image quality port of the image server providing a lowest level of image quality. The image 210 may then be queried and retrieved in a second query message using software port number 106 corresponding to a DICOM image quality port of the image server providing a maximum level of image quality.

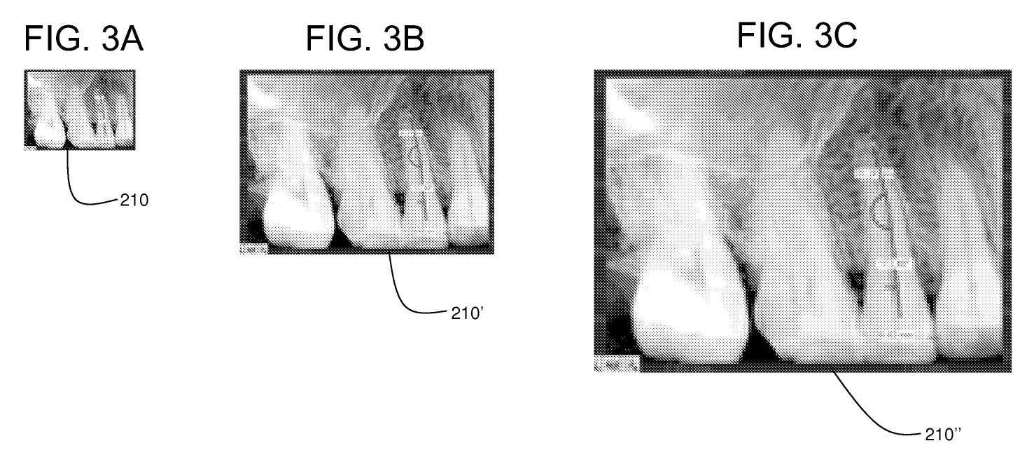

For example, FIGS. 3A-3C illustrate images retrieved using the system of FIG. 1 using three different image quality software ports of increasing levels of image quality, in accordance with an embodiment of the present invention. The image 210 was retrieved via a first image quality software port of an image server providing a lowest level of image quality (e.g., as a thumbnail image using software port number 104). The image 210′ was retrieved via a second image quality software port of the same image server providing an intermediate level of image quality (e.g., 50% of a maximum level of image quality using software port number 105). The image 210″ was retrieved via a third image quality software port of the same image server providing a maximum level of image quality (e.g., software port number 106). The images 210, 210′, and 210″ are all the same image, but each at a different level of image quality.

The process of selecting a level of image quality (i.e., an image quality software port number) may be done manually by a user or automatically by the medical imaging software application 115. For example, the medical imaging software application 115 may be configured to always use the lowest image quality port number any time six or more images are to be retrieved based on a single query. Furthermore, the medical imaging software application 115 may be configured to always use the maximum image quality port number whenever a single image is to be retrieved based on a single query. Other rules of automation may be defined as well.

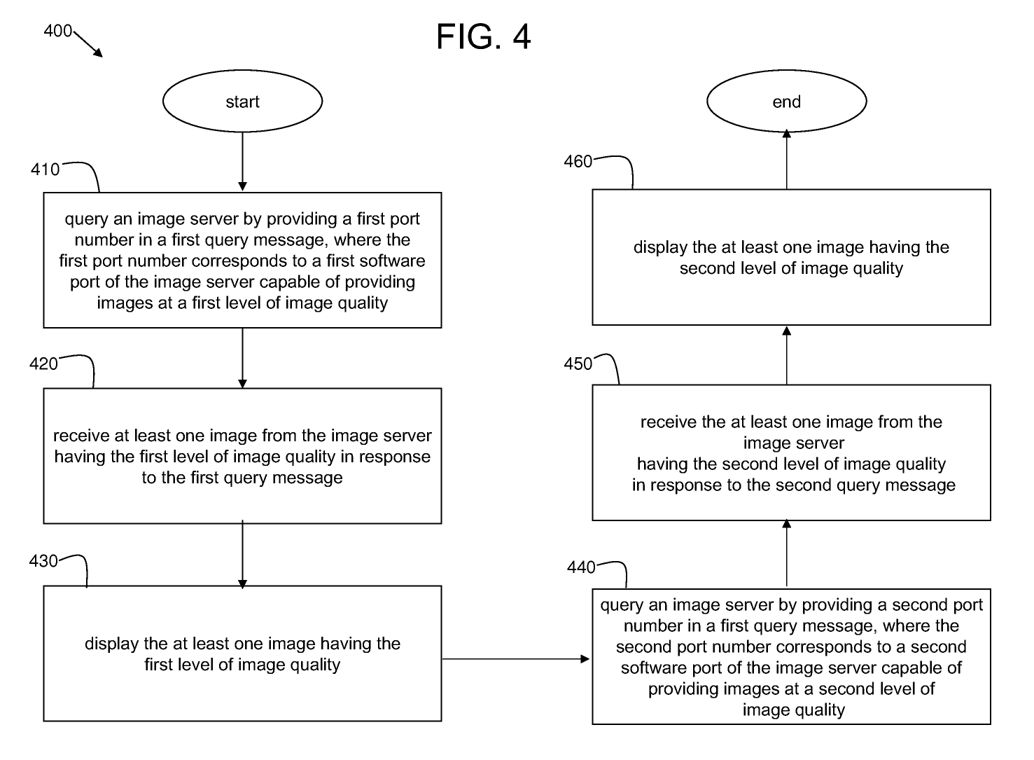

FIG. 4 is a flowchart of an embodiment of a method 400 of querying an image server providing multiple image quality software ports using the system of FIG. 1. In step 410, query an image server by providing a first port number in a first query message, where the first port number corresponds to a first software port of the image server capable of providing images at a first level of image quality. In step 420, receive at least one image from the image server having the first level of image quality in response to the first query message. In step 430, display the at least one image having the first level of image quality. In step 440, query the image server by providing a second port number in a second query message, where the second port number corresponds to a second software port of the image server capable of providing images at a second level of image quality. In step 450, receive the at least one image from the image server having the second level of image quality in response to the second query message. In step 460, display the at least one image having the second level of image quality.

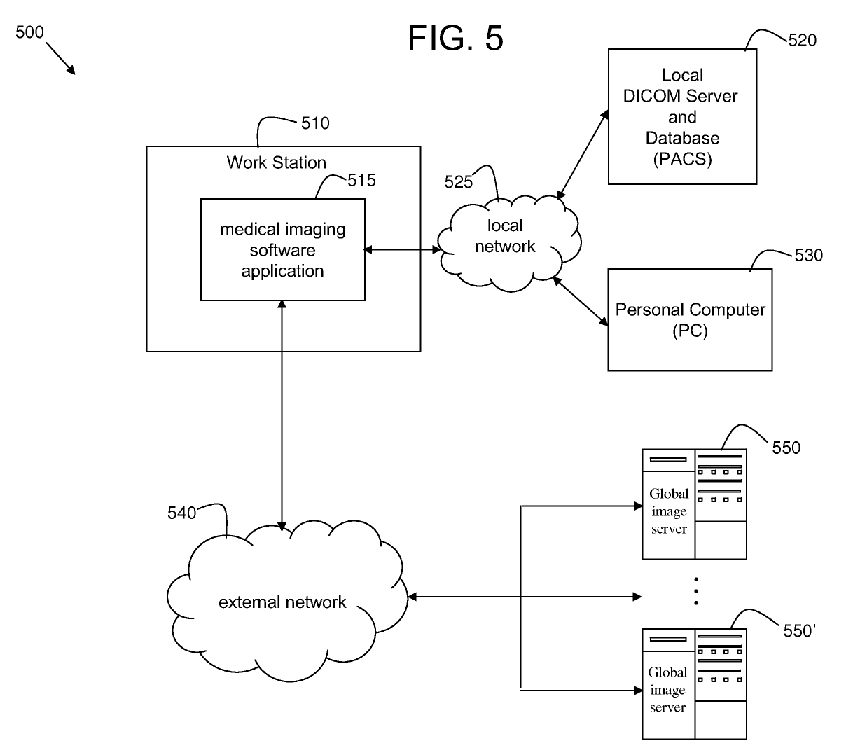

In accordance with other embodiments of the present invention, image servers may have image confidentiality software ports (similar to the image quality software ports described above herein) configured to provide images of varying levels of patient anonymity. FIG. 5 illustrates a system 500 that uses image servers, a software application, and multi-port methods for retrieving images of various patient anonymity levels via multiple image confidentiality software ports, in accordance with an embodiment of the present invention. A level of patient anonymity of an image depends on the type and amount of patient information provided in the image. For example, an image having a patient social security number as part of the image may represent an image having a low level of patient anonymity. An image having no patient information as part of the image may represent an image having a high level of patient anonymity. An image having a last name of a patient as part of the image may represent an image having an intermediate level of patient anonymity. Other definitions of levels of patient anonymity are possible as well, in accordance with various embodiments of the present invention.

The system 500 includes a medical imaging software application 515 residing on a work station 510. The software application 515 is used to query image servers to retrieve medical images which may be displayed and viewed on the work station 510 by a user. The system also includes a local imaging server 520 being that of a local DICOM server and database. The local server 520 may serve as a PACS (Picture Archive and Communication System) as used in a radiology department of a healthcare facility such as a hospital or a doctor's office, for example. Again, a PACS system may manage the details of imaging related tasks within a facility including acquisitions, archiving, manipulation, and display.

The system 500 further includes a local network 525 (e.g., a local area network) operatively connecting the work station 510 and the local server 520. The system may further include a personal computer (PC) 530 operatively connected to the local network 525. The system also includes a plurality of global image servers 550-550′ (e.g., DICOM database servers) and an external network 540 (e.g., the Internet) operatively connecting the work station 510 to the global image servers 550-550′. Again, as used herein, the term “DICOM database server” refers to a DICOM server and associated database(s). A DICOM database server is capable of storing and/or archiving at least medical image information.

In accordance with an embodiment of the present invention, the local image server 520 and the global image servers 550-550′ each include three image confidentiality software ports. An image confidentiality software port, as used herein, is a software port of an image server that is capable or providing images or image data via that software port having a particular predetermined level of patient anonymity. For example, a first software port may provide images at a maximum level of patient anonymity, a second software port may provide images at an intermediate level of patient anonymity, and a third software port may provide images at a low level of patient anonymity.

A software port number uniquely identifies a particular service on a host server or computer. For example, in order for an image server to accept connections from remote workstations and computers, the image server binds each image server application to a local software port. The image server uses the local port to listen for and accept connections from remote systems. Once a remote system is connected, the image server may send the requested images to the remote system and then disconnect from the remote system when finished. In accordance with an embodiment of the present invention, image server applications corresponding to images of a particular level of patient anonymity are bound to a particular image confidentiality software port.

By allowing images to be retrieved from image servers at different levels of patient anonymity (via multiple image confidentiality software ports), patient confidentiality may be more adequately controlled to comply with HIPPA (Health Insurance Portability and Accountability Act) regulations. For example, a user of the medical imaging software application 515 on the medical work station 510 may desire to view a set of dental X-ray images. The dental X-ray images reside on the local image server 520 or a global image server 550, and the software application 515 is capable of querying the correct image server for the images and retrieving those images (e.g., using the DICOM protocol). For example, if the desired images reside on the local image server 520 then, if the user retrieves the set of dental X-ray images at the maximum level of patient anonymity (e.g., having no related patient-identifying information in the images), HIPPA compliance may be insured.

Certain embodiments of the present invention, however, may allow the user to initially retrieve the set of dental X-ray images at a significantly higher level of patient anonymity (i.e., less or no patient-specific information associated with the images), allowing the user to look at the full set of images and decide which of those images the user is really interested in for full examination. For example, the user may only be interested in one or two images of a set of a dozen images corresponding to a plurality of patients. The user may select the one or two images from the initially retrieved set of images and query the local image server 120 to retrieve those one or two images, but at a lower level of patient anonymity (i.e., having more patient-identifying information). In this manner, the user does not have to be inadvertently made aware of the identity of patients associated with images that the user is not interested in examining.

Embodiments of the present invention allow images to be retrieved at different levels of patient anonymity by providing an image server with multiple software ports where each software port corresponds to a different level of patient anonymity. When the medical imaging software application 515 makes a query to an image server to retrieve an image(s), the query message from the medical imaging software application 515 not only includes an IP address of the image server, but also includes an image confidentiality software port number corresponding to the level of patient anonymity at which the image(s) are to be retrieved.

In accordance with an embodiment of the present invention, the medical imaging software application 515 may be stored on a computer readable medium such as, for example, a compact disk (CD) for distribution. In accordance with other alternative embodiments of the present invention, the medical imaging software application 515 may reside on the PC 530 which operatively interfaces to the work station 510 via the local network 525, or may reside on the local image server 520, for example.

An image server specializes in delivering images. An image server may perform specialized processing tasks that are useful to a user including, for example, image rotation, color adjustment, and image blending. In accordance with an embodiment of the present invention, an image server may process an image, having a predefined minimum level of patient anonymity, in order to create corresponding images having higher levels of patient anonymity (e.g., by stripping the image data of certain patient information). The image is the same, but the level of patient anonymity is different. In this manner, an image server may provide duplicate images of various levels of patient anonymity such that any particular level of patient anonymity corresponds to a particular image confidentiality software port of the image sever. In other words, the image server may provide multiple image retrieval applications based on patient anonymity level, where each application is tied to a corresponding image confidentiality software port.

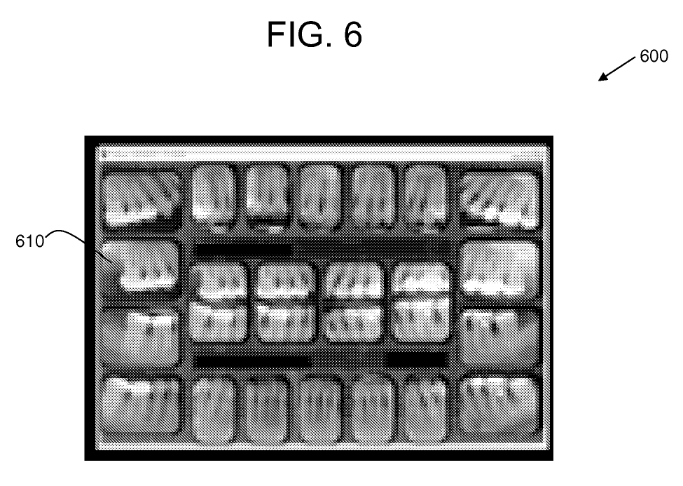

FIG. 6 illustrates a plurality of images 600 retrieved using the system 500 of FIG. 5 using an image confidentiality software port corresponding to a highest level of patient anonymity, in accordance with an embodiment of the present invention. The images 600 may be displayed to a user on a display of the workstation 510, for example. The images 600 do not have any patient-identifying information associated with them. The user may view the images 600 and decide he is interested in looking more closely at image 610, for example. As a result, the user selects the image 610 via the medical imaging software application 515 on the work station 510, selects a lower level of desired patient anonymity, and again sends out a query message to retrieve only the image 610, but at the selected lower level of patent anonymity (i.e., having some associated patient-identifying information).

When the user selects a different level of patient anonymity, the query message will include a different image confidentiality software port number of the image server. For example, the original set of images 600 may have been queried and retrieved using software port number 104 corresponding to a DICOM image confidentiality port of the image server providing a highest level of patient anonymity. The image 610 may then be queried and retrieved in a second query message using software port number 106 corresponding to a DICOM image confidentiality port of the image server providing a minimum level of patient anonymity (e.g., providing a full patient name and social security number).

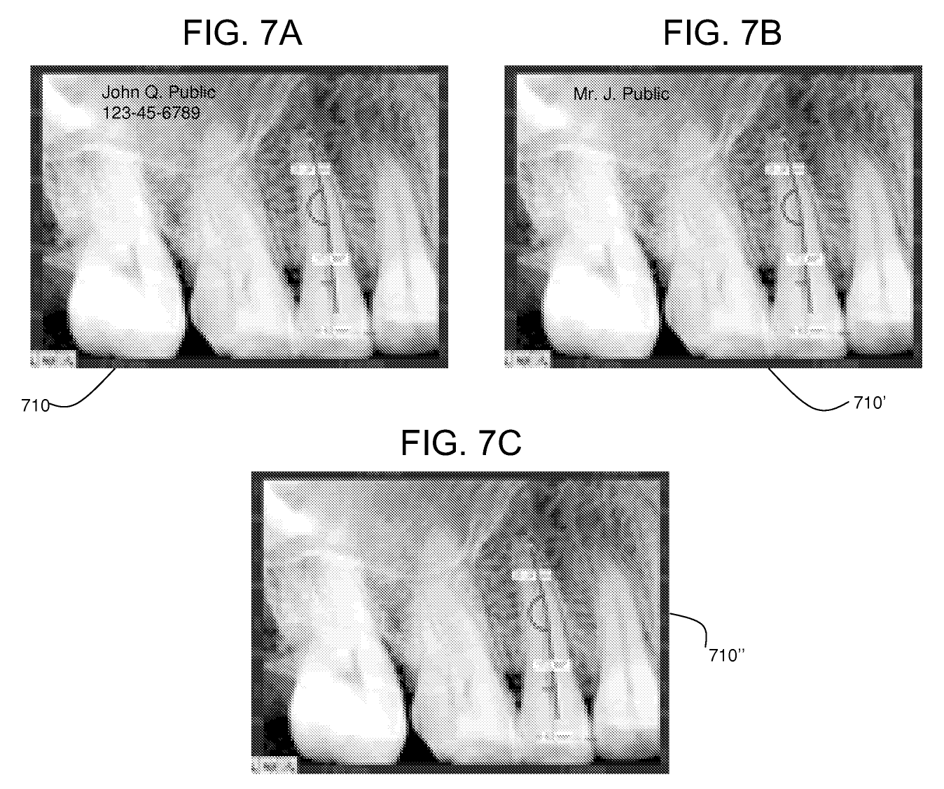

For example, FIGS. 7A-7C illustrate images retrieved using the system of FIG. 5 using three different image confidentiality software ports of increasing levels of patient anonymity, in accordance with an embodiment of the present invention. The image 710 was retrieved via a first image confidentiality software port of an image server providing a lowest level of patient anonymity (e.g., providing a full patient name and social security number using software port number 106). The image 710′ was retrieved via a second image confidentiality software port of the same image server providing an intermediate level of patient anonymity (e.g., providing a partial patient name using software port number 105). The image 710″ was retrieved via a third image confidentiality software port of the same image server providing a maximum level of patient anonymity (e.g., providing no associated patient information using software port number 104). The images 710, 710′, and 710″ are all the same image, but each at a different level of patient anonymity.

The process of selecting a level of patient anonymity (i.e., an image confidentiality software port number) may be done manually by a user, automatically by the medical imaging software application 515, or automatically by the image server. For example, the medical imaging software application 515 may be configured to always use the highest patient anonymity port number any time an unknown or unconfirmed user makes an image request. Furthermore, the medical imaging software application 515 may be configured to always use the lowest patient anonymity port number whenever a user who is verified as having access to a highest level of patient information makes an image request. Other rules of automation may be defined as well.

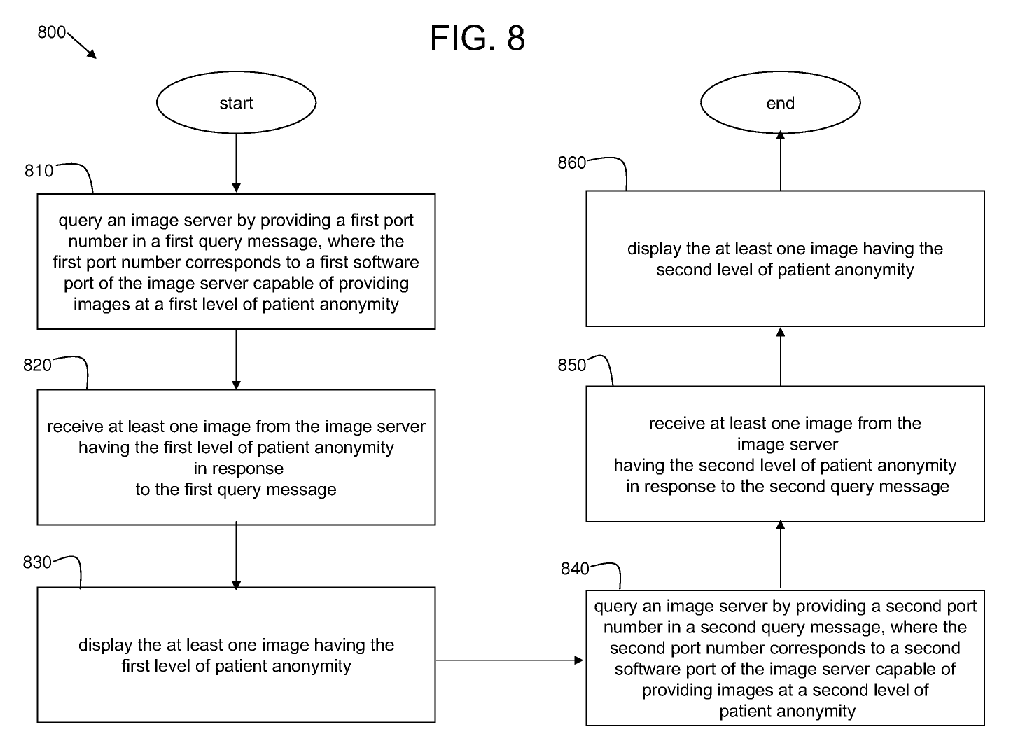

FIG. 8 is a flowchart of an embodiment of a method 800 of querying an image server providing multiple image confidentiality software ports using the system of FIG. 5. In step 810, an image server is queried by providing a first port number in a first query message, where the first port number corresponds to a first software port of the image server capable of providing images at a first level of patient anonymity. In step 820, at least one image is received from the image server having the first level of patient anonymity in response to the first query message. In step 830, the at least one image having the first level of patient anonymity is displayed. In step 840, the image server is queried by providing a second port number in a second query message, where the second port number corresponds to a second software port of the image server capable of providing images at a second level of patient anonymity. In step 850, at least one image from the image server is received having the second level of patient anonymity in response to the second query message. In step 860, the at least one image having the second level of patient anonymity is displayed.

An application entity title (AET) is an identifying name that is given to a server (server AET) and a client (client AET) to identify itself. Such AETs are often used to ensure that a client that is attempting to make a connection to a server has the right to make such a connection. For example, if the client attempting to make the connection does not specify the server AET, or specifies an incorrect server AET, then connection may be terminated. Each server typically maintains a list of client AETs that have permission to communicate with the server. If a client specifies a client AET that is not on the server's list, the connection may be terminated.

In accordance with an embodiment of the present invention, the system 500 of FIG. 5 may be configured for an image server to use a client AET sent in a image query message to determine an appropriate level of patient anonymity. For example, referring to FIG. 5, the global image server 550 may receive an image query message from the medical imaging software application 515 on the work station 510. The image query message includes a client AET corresponding to the client work station 510. The global image server 550, upon receiving the image query message over the external network 540, proceeds to determine a level of patient anonymity associated with the client AET. Such an association may be stored in a look-up-table on the global image server 550, for example.

For example, if the work station 510 corresponds to a client that simply performs an initial image quality check of the images and has no need for any specific patient-identifying information, the server 550 may determine that the associated level of patient anonymity is high. As a result, any images provided to the client will be provided via an image confidentiality software port of the image server 550 corresponding to a highest level of patient anonymity. If, on the other hand, the work station 510 corresponds to a client that handles medical insurance claims and, therefore, has a high need for specific patient-identifying information, the server 550 may determine that the associated level of patient anonymity is low. As a result, any images provided to the client will be provided via an image confidentiality software port of the image server 550 corresponding to a lowest level of patient anonymity. In accordance with an embodiment of the present application, the image server includes a software application that performs the determination of patient anonymity level based on the client AET.

Other client-identifying means, other than a client AET, may be included in an image query message, in accordance with alternative embodiments of the present invention, and used by an image server in a similar manner. For example, a client transfer identifier (ID) may be included in an image query message by a client. Different clients, having there own unique transfer IDs (or client AETs), may connect to a same software port of an image server but receive images of differing levels of patient anonymity based on the transfer ID of a client.

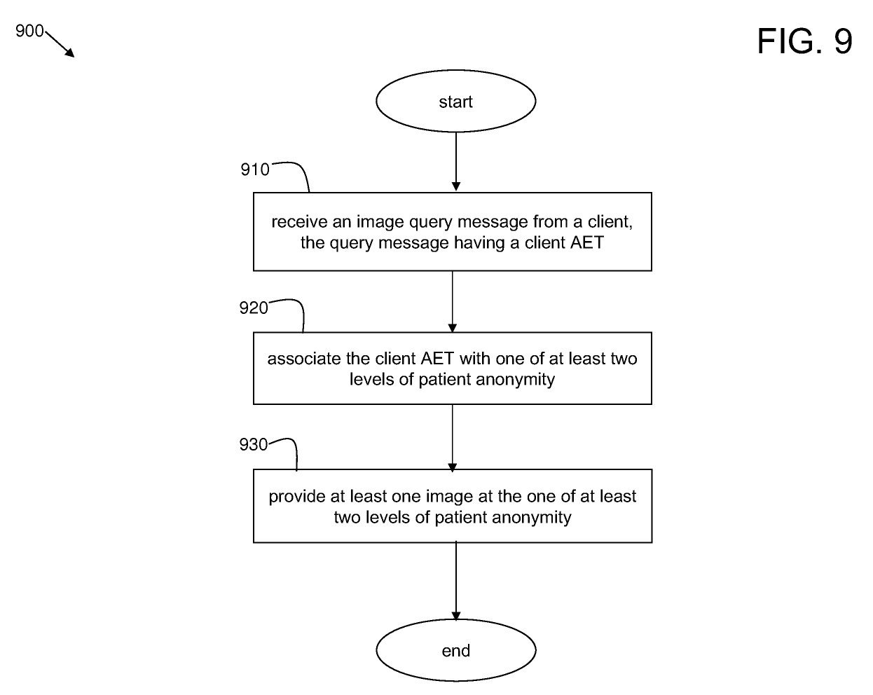

FIG. 9 is a flowchart of another embodiment of a method 900 of querying an image server providing multiple image confidentiality software ports using the system of FIG. 5. In step 910, an image query message from a client is received by an image server, where the query message includes a client application entity title (AET). In step 920, the client AET is associated with one of at least two levels of patient anonymity by the image server. In step 930, at least one image is provided by the image server to the client at the one of at least two levels of patient anonymity via an image confidentiality software port of the image server corresponding to a predefined level of patient anonymity, in response to the image query message.

In accordance with still another alternative embodiment of the present invention, an image server may provide a plurality of image software ports, where each image software port corresponds to a defined combination of both image quality and patient anonymity. For example, one image software port may correspond to a highest level of image quality and a lowest level of patient anonymity. Other combinations are possible as well, in accordance with various embodiments of the present invention.

In summary, image servers, methods, software applications, and computer readable medium for retrieving images of various levels of patient anonymity via multiple image confidentiality software ports are disclosed. In an image server, at least two image confidentiality software ports are provided, where each of the image confidentiality software ports is capable of providing images at a predetermined level patient anonymity, and where the predetermined level of patient anonymity is different for each of the image confidentiality software ports. Even though discussed herein in terms of medical image applications, certain other embodiments of the present invention may apply to other image retrieval applications as well.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. An image server providing at least two image confidentiality software ports, wherein each of said image confidentiality software ports is capable of providing images at a predetermined level of patient anonymity, and wherein said predetermined level of patient anonymity is different for each of said image confidentiality software ports.

2. An image server providing multiple image confidentiality software ports, said image server comprising:
a first software port capable of providing images at a first level of patient anonymity;
a second software port capable of providing said images at a second level of patient anonymity, wherein said second level of patient anonymity is different from said first level of patient anonymity; and
a third software port capable of providing said images at a third level of patient anonymity, wherein said third level of patient anonymity is different from said first level of patient anonymity and said second level of patient anonymity.

3. The image server of claim 2 wherein said first level of patient anonymity corresponds to a maximum level of patient anonymity.

4. The image server of claim 3 wherein said second level of patient anonymity corresponds to an intermediate level of patient anonymity.

5. The image server of claim 4 wherein said third level of patient anonymity corresponds to a minimum level of patient anonymity.

6. The image server of claim 2 wherein said images provided by said third software port are provided along with at least one of a patient name and a patient social security number.

7. The image server of claim 2 wherein a port number of said first software port is 104.

8. The image server of claim 7 wherein a port number of said second software port is 105.

9. The image server of claim 8 wherein a port number of said third software port is 106.

10. The image server of claim 2 wherein said image server comprises a Digital Imaging and Communications in Medicine (DICOM) Picture Archive and Communication System (PACS) server.

11. A method of querying an image server providing multiple image confidentiality software ports, said method comprising:
querying an image server by providing a first port number in a first query message, wherein said first port number corresponds to a first software port of said image server capable of providing images at a first level of patient anonymity;
receiving at least one image from said image server having said first level of patient anonymity in response to said first query message;
displaying said at least one image having said first level of patient anonymity;
querying said image server by providing a second port number in a second query message, wherein said second port number corresponds to a second software port of said image server capable of providing images at a second level of patient anonymity; and
receiving said at least one image from said image server having said second level of patient anonymity in response to said second query message.

12. The method of claim 11 further comprising displaying said at least one image having said second level of patient anonymity.

13. The method of claim 12 further comprising:
querying said image server by providing a third port number in a third query message, wherein said third port number corresponds to a third software port of said image server capable of providing images at a third level of patient anonymity; and
receiving said at least one image from said image server having said third level of patient anonymity in response to said third query message.

14. The method of claim 13 further comprising displaying said at least one image having said third level of patient anonymity.

15. A method of querying an image server, said method comprising providing one of a plurality of software port numbers in a query message, wherein each of said plurality of software port numbers corresponds to a different image confidentiality software port of said image server, and wherein said image server is capable of providing images at a different level of patient anonymity for each image confidentiality software port.

16. The method of claim 15 wherein a first software port number of said plurality of software port numbers corresponds to a first image confidentiality software port capable of providing images at a maximum level of patient anonymity.

17. The method of claim 16 wherein a second software port number of said plurality of software port numbers corresponds to a second image confidentiality software port capable of providing images at an intermediate level of patient anonymity.

18. The method of claim 17 wherein a third software port number of said plurality of software port numbers corresponds to a third image confidentiality software port capable of providing images at a minimum level of patient anonymity.

19. A software application, residing on a computer-based platform, capable of querying an image server by providing one of a plurality of software port numbers in a query message, wherein each of said plurality of software port numbers corresponds to a different image confidentiality software port of said image server, and wherein said image server is capable of providing images at a different level of patient anonymity for each image confidentiality software port.

20. A software application, residing on a computer-based platform, said software application being capable of:
querying an image server by providing a first port number in a first query message, wherein said first port number corresponds to a first software port of said image server capable of providing images at a first level of patient anonymity;
receiving at least one image from said image server having said first level of patient anonymity in response to said first query message;
displaying said at least one image having said first level of patient anonymity;
querying said image server by providing a second port number in a second query message, wherein said second port number corresponds to a second software port of said image server capable of providing images at a second level of patient anonymity; and
receiving said at least one image from said image server having said second level of patient anonymity in response to said second query message.

21. The software application of claim 20, wherein said software application is further capable of displaying said at least one image having said second level of patient anonymity.

22. The software application of claim 21, wherein said software application is further capable of:
querying said image server by providing a third port number in a third query message, wherein said third port number corresponds to a third software port of said image server capable of providing images at a third level of patient anonymity; and
receiving said at least one image from said image server having said third level of patient anonymity in response to said third query message.

23. The software application of claim 22, wherein said software application is further capable of displaying said at least one image having said third level of patient anonymity.

24. A non-transitory computer readable medium having encoded thereon computer executable instructions for performing a method, wherein said method comprises querying an image server by providing one of a plurality of software port numbers in a query message, wherein each of said plurality of software port numbers corresponds to a different image confidentiality software port of said image server, and wherein said image server is capable of providing images at a different level of patient anonymity for each image confidentiality software port.

25. A non-transitory computer readable medium having encoded thereon computer executable instructions for performing a method, wherein said method comprises:
querying an image server by providing a first port number in a first query message, wherein said first port number corresponds to a first software port of said image server capable of providing images at a first level of patient anonymity;
receiving at least one image from said image server having said first level of patient anonymity in response to said first query message;
displaying said at least one image having said first level of patient anonymity;
querying said image server by providing a second port number in a second query message, wherein said second port number corresponds to a second software port of said image server capable of providing images at a second level of patient anonymity; and
receiving said at least one image from said image server having said second level of patient anonymity in response to said second query message.

26. The computer readable medium of claim 25 wherein said method further comprises displaying said at least one image having said second level of patient anonymity.

27. The computer readable medium of claim 26 wherein said method further comprises:
querying said image server by providing a third port number in a third query message, wherein said third port number corresponds to a third software port of said image server capable of providing images at a third level of patient anonymity; and
receiving said at least one image from said image server having said third level of patient anonymity in response to said third query message.

28. The computer readable medium of claim 27 wherein said method further comprises displaying said at least one image having said third level of patient anonymity.

29. A method of querying an image server, said method comprising receiving an image query message from a client, said query message having a client application entity title (AET), associating said client AET with one of at least two levels of patient anonymity, and providing at least one image at said one of at least two levels of patient anonymity, via an image confidentiality software port corresponding to a predefined level of patient anonymity, in response to said image query message.

30. A method of querying an image server, said method comprising providing a client application entity title (AET) in a query message to said image server, wherein said client AET is associated by said image server with one of at least two levels of patient anonymity, and wherein said image server is configured to provide images at said at least two levels of patient anonymity, via image confidentiality software ports each corresponding to a predefined level of patient anonymity, in response to said query message.

31. A software application, residing on an image server, configured to receive an image query message from a client, said query message having a client application entity title (AET), wherein said software application is further configured to associate said client AET with one of at least two levels of patient anonymity, and wherein said software application is configured to provide images at said at least two levels of patient anonymity, via image confidentiality software ports each corresponding to a predefined level of patient anonymity, in response to said image query message.

32. A non-transitory computer readable medium having encoded thereon computer executable instructions for performing a method, wherein said method comprises receiving an image query message from a client, said query message having a client application entity title (AET), associating said client AET with one of at least two levels of patient anonymity, and providing at least one image at said one of at least two levels of patient anonymity, via an image confidentiality software port corresponding to a predefined level of patient anonymity, in response to said image query message.

33. A method of querying an image server, said method comprising receiving an image query message from a client, said query message having a client transfer identifier (ID), associating said client transfer ID with one of at least two levels of patient anonymity, and providing at least one image at said one of at least two levels of patient anonymity, via an image confidentiality software port in response to said image query message.

34. A method of querying an image server, said method comprising:
receiving a first image query message from a first client, said first query message having a first client transfer identifier (ID), associating said first client transfer ID with one of at least two levels of patient anonymity, and providing at least one image at said one of at least two levels of patient anonymity to said first client, via a software port in response to said first image query message; and
receiving a second image query message from a second client, said second query message having a second client transfer identifier (ID), associating said second client transfer ID with said one of at least two levels of patient anonymity, and providing at least one image at said one of at least two levels of patient anonymity to said second client, via said software port in response to said second image query message.
